(19) United States
(12) Patent Application Publication
(10) Pub. No.: US 2007/0012760 A1
(43) Pub. Date: Jan. 18, 2007

(54) ID confirmation unit

(76) Inventors: Robert Michael Errato, Hamden, CT (US); Mark A. Millett, Guilford, CT (US)

Correspondence Address: BACHMAN & LAPOINTE, P.C., 900 CHAPEL STREET, SUITE 1201, NEW HAVEN, CT, 06510, US

(21) Appl. No.: 11/181,617

(22) Filed: Jul. 14, 2005

(51) Int. Cl. G06K 5/00

(52) U.S. Cl. 235/380

(57) ABSTRACT

An identification confirmation unit is provided which includes a unit for gathering an individual's physical/biometric characteristics and data stored in and on an identification card and a processor for processing information about the characteristics and data to confirm the individual's identity and for verifying that the identification card has not been altered or forged. A method for confirming the identity of an individual is provided. The method comprises the steps of inserting an identification card into an identification confirmation unit, taking an image of at least one side of the inserted identification card, gathering embedded data from the identification card and uploading the gathered data to a processing unit, capturing at least one live image of the individual and uploading the captured image to the processing unit, and confirming the identity of the individual with the processing unit.

### BACKGROUND OF THE INVENTION

(1) Field of the Invention

The present invention relates to an identification (ID) confirmation unit which reduces or eliminates the ability of an individual to present a fraudulent ID.

(2) Prior Art

Security systems for verifying identification have been existent for some time. U.S. Pat. No. 6,119,932 to Maloney et al. illustrates an identification verification apparatus and method. The apparatus includes a camera for capturing an image of the user and a storage device that stores the captured image. The identification system further has a microprocessor and a data detection device coupled to the microprocessor. The microprocessor has an associated memory structure, and the data detection device is operable to extract data from an identification card presented by the user. The extracted data is stored in the memory structure. The improvement also includes a device for superimposing selected portions of the extracted data upon the captured image of the user. A method of identifying a person presenting an identification card is also provided which includes the steps of recording an image of the person and retrieving identification information from the identification card. In addition, the method includes the step of superimposing at least a portion of the retrieved identification information on the recorded image. The method further provides for creating a database entry from the retrieved identification information.

Despite the existence of such a system, there remains a need for a better system which can be used in a variety of settings.

### SUMMARY OF THE INVENTION

Accordingly, the present invention provides an identification confirmation unit which reduces or eliminates the ability of an individual to present a fraudulent ID.

In accordance with the present invention, an identification confirmation unit is provided which broadly comprises means for gathering an individual's physical/biometric characteristics and data stored in and on an identification card and means for processing the characteristics and data to confirm the individual's identity and for verifying that the identification card has not been altered or forged.

Further in accordance with the present invention, a method for confirming the identity of an individual is provided. The method broadly comprises the steps of inserting an identification card into an identification confirmation unit, taking an image of at least one side of the inserted identification card, gathering embedded data from the identification card and uploading the gathered data to a processing unit, capturing at least one live image of the individual and uploading the captured image to the processing unit, and confirming the identity of the individual with the processing unit.

Other details of the identification confirmation unit of the present invention, as well as other objects and advantages attendant thereto, are set forth in the following detailed description and the accompanying drawings wherein like reference numerals depict like elements.

### BRIEF DESCRIPTION OF THE DRAWINGS

FIG. 1 is a schematic representation of an identification confirmation unit in accordance with the present invention;

FIG. 2 is a schematic representation of a base unit portion for use in the identification confirmation unit.

FIG. 3 is a schematic representation of an alternative base unit for use in the identification confirmation unit.

FIG. 4 is a schematic representation of a still another alternative base unit for use in the identification confirmation unit.

FIG. 5 is a flow chart showing the method for confirming the identity of an individual.

### DETAILED DESCRIPTION OF THE PREFERRED EMBODIMENT(S)

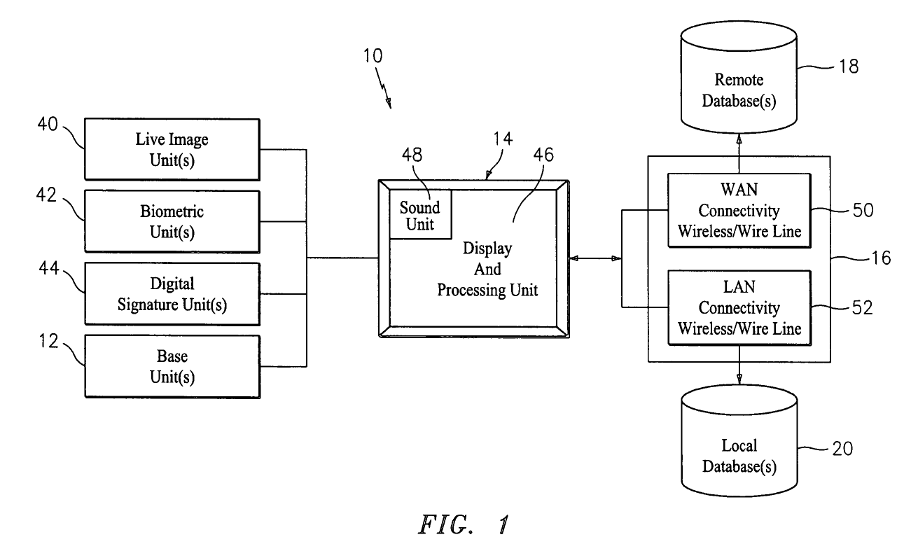

Referring now to FIG. 1, an embodiment of an identification (ID) confirmation unit 10 in accordance with the present invention is illustrated. The confirmation unit 10 includes a base unit 12, a processing and display unit 14, and a connection unit 16 to one or more remote databases 18 and to one or more local databases 20. The confirmation unit 10 may have other modules, which will be discussed hereinafter.

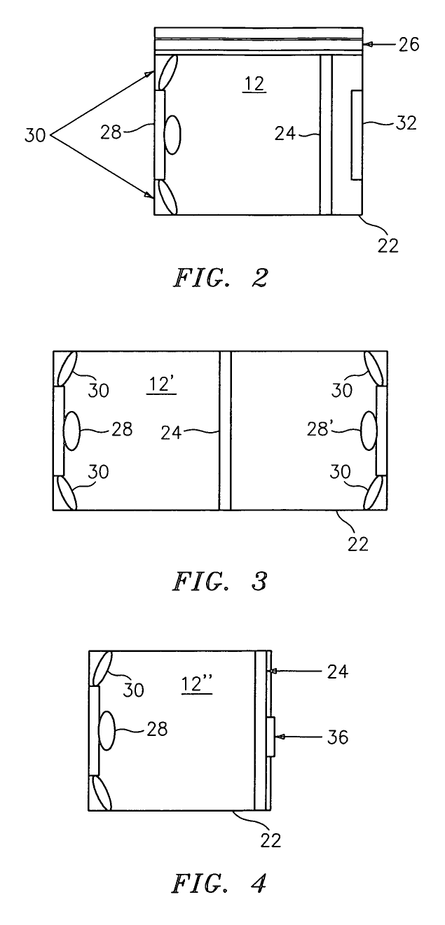

Referring now to FIG. 2, the base unit 12 preferably includes a housing 22 with a slot 24 into which an identification card, such as a passport, a driver's license, or a government issued identification card can be inserted. The unit 12 also preferably includes a reader 26 for reading information contained in a magnetic stripe on the identification card. The reader 26 may be attached to an external surface of the housing 22 or may be at least partially internal to the housing 22. The base unit 12 includes internal means 28 for capturing information on at least one side of the identification card. The information capturing means may be one or more board camera(s) and appropriate lens(es). In order to ensure that the information is captured by the camera(s), one or more light sources 30 may be incorporated into the housing 22 to illuminate the side(s) of the identification containing the information to be captured. Still further, the base unit 12 may include an internal optical PDF barcode reader with light source to capture information in a barcode on the identification card.

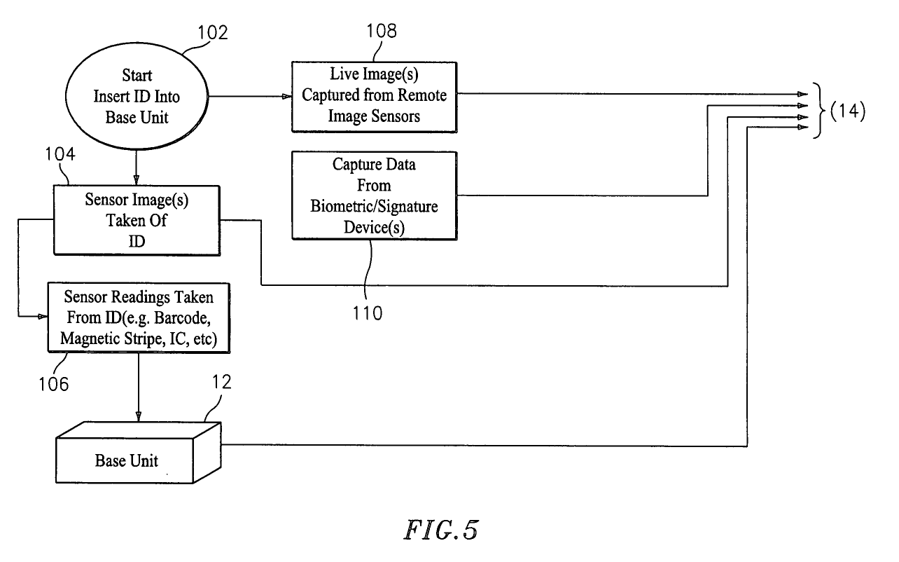

Referring now to FIG. 3, there is illustrated a base unit 12′ variations which includes two sets of camera(s) and lens(es) 28 and 28′ for capturing information on both sides of an identification card inserted into the slot 24. Both sets of camera(s) and lens(es) 28 and 28′ may have one or more light sources 30 for illuminating the opposed sides of an identification card inserted into the slot 24. In addition to the two sets of camera's and lens(es) 28 and 28′ and the light sources 30, the base unit 12′ may have other features such as a magnetic stripe reader 26 and an optical PDF barcode reader 32 with light source.

Still another embodiment of a base unit 12″ is illustrated in FIG. 4. In this embodiment, there is a slot 24 into which an identification card is inserted. Inside the housing 22, at least one camera and lens 28 and one or more light sources 30. Also included within the housing is a radio frequency identification (RFID) sensor 36 for scanning encoded information embedded in integrated circuits (IC) in the identification card inserted into the slot 24. As before, this base unit may also include other features such as a magnetic stripe reader 26 and an optical barcode reader 32 with light source.

As mentioned above, the camera(s) and the lens(es) 28 in the base unit(s) may be used to capture an image of the information and data contained on one or more sides of an identification card inserted into the slot 22 including the portrait of the individual depicted on the card, the signature block posted on the card, and character data printed on the card. The image(s) thus captured may be forwarded to the processing unit 14 using any suitable means known in the art.

Information and data on the identification card contained in a magnetic stripe can be read by the reader 26 and also forwarded to the processing unit 14. Similarly, information and data contained in a bar code may be read by the barcode reader 32 and forwarded to the processing unit 14. Still further, encoded information and data embedded within the identification card can be read by the RFID sensor 36 and forwarded to the processing unit.

Referring again to FIG. 1, the confirmation unit 10 may further include one or more units 40 for capturing a live image of the individual presenting the identification card. The unit(s) 40 may comprise one or more cameras mounted to the housing 22 or to another structure. The unit(s) 40 may be used to take a frontal picture of the individual as well a profile of the individual. The images captured by the unit(s) 40 may also be forwarded to the processing unit.

Still further, the confirmation unit 10 may include one or more biometric units 42 for capturing (1) one or more fingerprint(s) of the individual presenting the identification card; (2) for scanning the retina or facial features of the individual; (3) for capturing the voiceprint of the individual; and/or (4) for obtaining a DNA profile of the individual. The biometric unit(s) 42 may comprise any suitable conventional biometric unit(s) known in the art for carrying out these functions such as fingerprinting unit, a retina scan unit, a facial scan unit, a speech analyzer, and a DNA extraction unit.

The confirmation unit may further include a digital signature unit 40 for obtaining a signature from the individual present the identification card.

The information obtained by the biometric unit(s) 42 and any digital signature unit 44 may be forwarded to the processing unit 14 using any suitable means known in the art.

The processing unit 14 may include any suitable processor known in the art and may be programmed in any suitable language to carry out the functions described hereinafter. The processing unit 14 also includes a display unit 46 whose function will also be described hereinafter. The display unit 46 may comprise any suitable display unit known in the art.

If desired, the processing unit 14 may include means 48 for generating an audible sound when a discrepancy is detected. The audible sound generating means 48 may comprise any suitable means known in the art for generating an audible sound.

The connection unit 16 may include any suitable means known in the art for connecting the processing unit 14 with one or more remote database(s) 18 and one or more local database(s) 20. For example, the connection unit 16 may include a WAN connectivity wireless wire line 50 for connecting the processing unit 14 to the remote database(s) 18. Still further, the connection unit 16 may include a LAN connectivity wireless/wire line 52 for connecting the processing unit 14 to the local database(s) 20. The connection unit 16 allows two way communication between the processing unit 14 and the database(s) 18 and/or 20. Thus, the connection unit 16 may be used for data storage and retrieval purposes as well as querying WAN databases for information regarding security/management concerns as they may relate to the individual presenting the identification card.

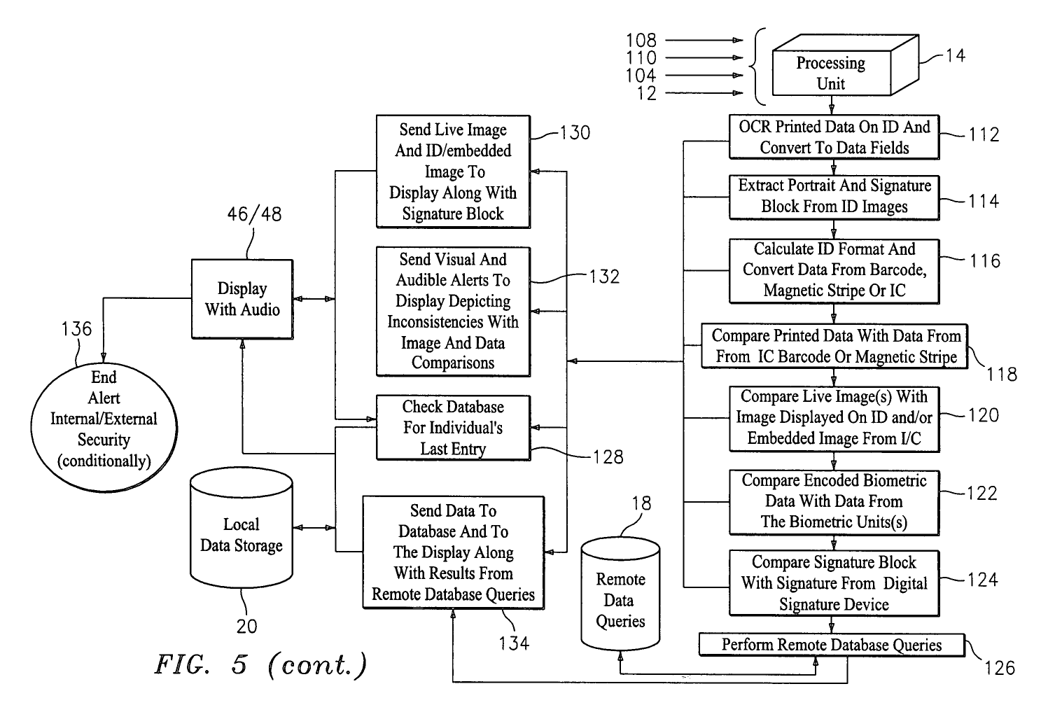

FIG. 5 is a flow chart illustrating the identification confirmation method of the present invention. The method begins with the insertion of the identification card into the base unit 12, 12′ or 12″ as shown in step 102. In step 104, the image(s) of the identification card side(s) are taken by the camera(s) and lens(es) units 28. The images are uploaded into the processing unit 14. In step 106, embedded data (e.g. barcode/integrated circuit/magnetic stripe) is gathered from the identification card and uploaded to the processing unit 14.

In step 108, one or more live images of the individual presenting the identification card are captured by remote image sensors and uploaded to the processing unit 14. In step 110, biometric information is gathered and uploaded to the processing unit. The biometric information may include: (1) a fingerprint of the individual being captured from a fingerprint biometric unit and uploaded to the processing unit 14; (2) a retina/facial scan of the individual is captured and uploaded to the processing unit 14; (3) a voice pattern of the individual is captured by a voice analysis unit biometric unit) and uploaded to the processing unit 14; (4) a DNA sample is obtained from the individual by a DNA extraction unit and uploaded to the processing unit 14; and/or (5) a signature is obtained from the individual via a digital signature unit and uploaded to the processing unit.

Within the processing unit 14, the following comparative preprocessing steps and processing steps may be performed. As shown in box 112, the printed data contained in the images taken from the identification card are converted to data fields by using OCR (optical character reader) type technologies. As shown in box 114, the portrait and signature block are extracted from the identification card images. Additionally, as shown in box 116, the data gathered from the barcode, magnetic stripe, or integrated circuit are analyzed to calculate the format of the identification and are then converted to data fields. In box 118, the printed data extracted from the identification card is compared to the data extracted from the encoded/embedded data. Any discrepancies may be depicted on the display unit 46 and an audible tone may be issued by the unit 48 to alert a monitor operating the unit 10. Additional processes may also be automatically initiated such as mechanical gates and other security mechanisms.

As shown in step 120, the live image may be compared via facial recognition to the image taken from the portrait on the identification card as well as embedded images in the identification card. Any discrepancies may be depicted on the unit 46 along with an audible tone from unit 48.

In step 122, the fingerprint of the individual extracted from the biometric device is compared to the fingerprint data extracted from the identification card. Again any discrepancies may be depicted on the unit 46 along with an audible tone from unit 48.

Further, in step 122, the retinal/facial scan data of the individual extracted from the biometric device may be compared to the retinal/facial data extracted from the identification card. Any discrepancies may be depicted on the unit 46 along with an audible tone from unit 48.

Also in step 122, the voiceprint of the individual from the speech pattern analyzer may be compared to that of the speech profile extracted from the identification card. Any discrepancies may be depicted on the unit 46 along with an audible tone from unit 48.

Still further in step 122, the DNA profile of the individual from the DNA extraction unit may be compared to that of the DNA profile extracted from the identification card. Any discrepancies may be depicted on the unit 46 along with an audible tone from unit 48.

In step 124, the signature of the individual from the digital signature unit is compared to that of the signature block extracted from the identification card. Any discrepancies may be depicted on the unit 46 along with an audible tone from unit 48.

In step 126, the individual's data profile may be compared to remote alert flag databases.

In step 128, a check to local database 20 for the individual's last entry time, date, and status is performed. In step 130, live image information and data and IC/embedded image information and data are sent to display 46 along with the signature block. In step 132, visual and audible alerts are sent to display 46 and unit 48 depicting inconsistencies with image and data comparisons. In step 134, data is sent to the local data storage base 20 and to display 46 along with the results from any remote database queries.

Finally, in step 136, internal/external security is alerted if discrepancy or remote flags exist.

The ID confirmation unit of the present invention can be used in a wide variety of settings. For example, the ID confirmation unit can be used as part of airport security systems, entry portals for bars and nightclubs, building security systems, bank checking systems, etc. The ID confirmation unit of the present invention verifies that an identification card has not been forged or altered.

It is apparent that there has been provided in accordance with the present invention an identification confirmation unit which fully satisfies the objects, means, and advantages set forth hereinbefore. While the present invention has been described in the context of specific embodiments thereof, other alternatives, modifications, and variations will become apparent to those skilled in the art having read the foregoing description. Accordingly, it is intended to embrace those alternatives, modifications, and variations as fall within the broad scope of the appended claims.

What is claimed is:

1. An ID confirmation unit comprising:
means for gathering an individual's physical/biometric characteristics and data stored in and on an identification card; and
means for processing the characteristics and data to confirm the individual's identity and for verifying that the identification card has not been altered or forged.

2. The ID confirmation unit of claim 1, wherein said gathering means includes a means for capturing information and data located on and in said identification card and wherein said capturing means comprises at least one means for collecting images on at least one side of said identification card.

3. The ID confirmation unit of claim 2, wherein said capturing means comprises at least one means for collecting images on two sides of said identification card.

4. The ID confirmation unit of claim 2, wherein said capturing means further comprises a reader for reading a barcode and/or a magnetic stripe on said identification card.

5. The ID confirmation unit of claim 2, wherein said capturing means further comprises an RFID reader for capturing information on an integrated circuit within said identification card.

6. The ID confirmation unit of claim 1, wherein said capturing means comprises means for capturing a live image of a person presenting said identification card.

7. The ID confirmation unit of claim 1, wherein said capturing means comprises means for capturing biometric data about the individual.

8. The ID confirmation unit of claim 7, wherein said biometric capturing means comprises means for capturing data in the form of an individual's fingerprints.

9. The ID confirmation unit of claim 7, wherein said biometric capturing means comprises means for capturing an individual's retinal profile.

10. The ID confirmation unit of claim 7, wherein said biometric capturing means comprises means for capturing an individual's facial profile.

11. The ID confirmation unit of claim 7, wherein said biometric capturing means comprises means for capturing an individual's voice profile.

12. The ID confirmation unit of claim 7, wherein said biometric capturing means comprises means for capturing an individual's DNA profile.

13. The ID confirmation unit of claim 1, further comprising means for connecting said unit with a local database for data storage and retrieval purposes.

14. The ID confirmation unit of claim 1, further comprising means for connecting said unit to at least one remote database for information regarding security/management concerns relating to the individual presenting the identification card.

15. The ID confirmation unit of claim 1, further comprising means for inserting the identification card into said unit.

16. The ID confirmation unit of claim 1, further comprising a display unit for displaying information and data gathered from said identification card and for displaying discrepancies.

17. The ID confirmation unit of claim 1, further comprising means for generating an audible sound in the event of a discrepancy.

18. A method for confirming the identity of an individual comprising the steps of:
inserting an identification card into an identification confirmation unit;
taking an image of at least one side of said inserted identification card;
gathering embedded data from said identification card and uploading said gathered data to a processing unit;
capturing at least one live image of said individual and uploading said captured image to said processing unit; and
confirming the identity of said individual with said processing unit.

19. The method of claim 18, further comprising capturing at least one fingerprint of the individual and uploading the captured fingerprint to said processing unit.

20. The method of claim 18, further comprising scanning an individual's retina and uploading data about said scanned retina to said processing unit.

21. The method of claim 18, further comprising scanning an individual's profile and uploading data about said scanned profile to said processing unit.

22. The method of claim 18, further comprising capturing a voice pattern of the individual and uploading the captured voice pattern to said processing unit.

23. The method of claim 18, further comprising obtaining a DNA sample from the individual and uploading information about said DNA sample to said processing unit.

24. The method of claim 18, further comprises obtaining a signature from said individual and uploading information about said signature to said processing unit.

25. The method of claim 18, wherein said confirming step comprises:
converting data in said identification card image to a first set of data fields;
extracting a portrait and a signature block from said identification card image;
analyzing said embedded data and converting said analyzed data to a second set of data fields; and
comparing printed data extracted from the identification to data extracted from the encoded/embedded data.

26. The method of claim 25, further comprising depicting any discrepancy from said compared data on a display unit.

27. The method of claim 26, further comprising sounding an audible tone if any discrepancy is detected.

28. The method of claim 26, further comprising activating a security mechanism.

29. The method of claim 25, further comprising comparing the live image to the image extracted from said portrait and to any image embedded in the identification card.

30. The method according to claim 29, further comprising depicting any discrepancy from said compared images on a display unit.

31. The method of claim 30, further comprising sounding an audible tone if any discrepancy is detected.

32. The method of claim 29, further comprising comparing a fingerprint of the individual extracted from a biometric device to fingerprint data extracted from the identification card.

33. The method of claim 29, further comprising comparing retinal scan data extracted from a biometric device to retina data extracted from the identification card.

34. The method of claim 29, further comprising comparing facial scan data extracted from a biometric device to facial scan data extracted from the identification card.

35. The method of claim 29, further comprising comparing a voiceprint of the individual from a speech pattern analyzer to a speech profile extracted from the identification card.

36. The method of claim 29, further comprising comparing a DNA profile of the individual from a DNA extraction unit to a DNA profile extracted from the identification card.

37. The method of claim 29, further comprising comparing a signature of the individual from a digital signature unit to the signature block extracted from the identification.

38. The method of claim 18, wherein said confirming step comprises sending live image, embedded image, and a signature block to a display unit and to a database.
